(19) United States
(12) Patent Application Publication
(10) Pub. No.: US 2020/0179799 A1
(43) Pub. Date: Jun. 11, 2020

(54) Customizable Thumb Grip Covers

(71) Applicant: Joy Tops LLC, Los Angeles, CA (US)

(72) Inventors: Brandon Ramcheran, San Diego, CA (US); Carlos Montoya, Los Angeles, CA (US); Louis C. Paul, Westport, CT (US)

(21) Appl. No.: 16/620,480

(22) PCT Filed: Jun. 6, 2018
(86) PCT No.: PCT/US18/36204

§ 371 Date: Dec. 6, 2019

Related U.S. Application Data
(60) Provisional application No. 62/515,594, filed on Jun. 6, 2017.

(51) Int. Cl. A63F 13/24; A63F 13/98

(52) U.S. Cl. CPC A63F 13/24; A63F 2300/1043; A63F 13/98

(57) ABSTRACT

A thumb grip cover for an analog controller stick comprised of (a) a screw having (i) a head and (ii) a threaded shank, and (iii) a tip (b) a hardened body comprised of (i) a top surface having a center hole (ii) a bottom surface with a cut-out, preferably a wedge or channel, that ends at or close to the midpoint of the bottom surface (iii) sidewalls that connect the top surface and bottom surface and have an opening dimensioned to receive an uppermost portion of an analog controller stick, comprised of (xx) a hat (i.e., top) and (yy) a shaft wherein the uppermost portion of the analog controller stick is comprised of (xx) a hat and (yy) a shaft.

### CROSS-REFERENCE TO RELATED APPLICATIONS

The present application claims priority to a United States provisional patent application entitled “Customizable Universal Fit Thumb Grips,” having U.S. Ser. No. 62/515,594 and filed on Jun. 6, 2017, the disclosure of which is hereby incorporated by reference.

### FIELD OF INVENTION

Covers for analog controller sticks.

### BACKGROUND OF THE INVENTION

Thumb grips—covers that attach to the top of analog controller sticks—serve many purposes—protecting the stick from wear and tear, and providing an ability to modify/customize the appearance and feel of the stick. US Pre-Grant Application Publication 2017/0106274 (PG Pub '274), discussed immediately below, represents one prior art solution to the problem of lack of customization options.

PG Pub '274 discloses a cover attachment for an analog joystick controller (used in playing a video game). The cover attachment is described as comprised of an elastomeric body for receiving a controller joystick, a disk-shaped cover and a retainer ring formed for detachably coupling the cover and the elastomeric body.

The thumb grip cover for an analog controller stick of the present invention differs from the cover attachment for an analog joystick controller as disclosed in PG Pub '274 in several important aspects:

First, the thumb grip cover of the present invention is constructed of a non-elastomeric, hardened body, preferably a plastic.

Second, the thumb grip cover of the present invention is comprised of a screw, preferably a domed screw, which when torqued downward securely engages the top surface of the analog controller stick. Screws of different lengths may be provided, allowing the gamer to adjust the height of the thumb grip cover.

Third, the thumb grip cover of the present invention is preferably comprised of at least one, more preferably at least two, deformable inserts that engage with one or both of the top and/or the shaft of the analog controller stick.

Prior art thumb grip covers suffer certain limitations. Some are not compatible (i.e., appropriately sized) with certain analog controller sticks. Others do not remain securely affixed to the stick. Still others do not remain “centered” on the analog controller stick.

The concept of a “self-centering tactile thumb joystick” is discussed in U.S. Pat. No. 9,170,658 but in the context of removably mounting a thumb joystick on a touch screen of an electronic device. More particularly, by moving the “self-centering tactile thumb joystick” over a virtual directional pad displayed on the touch screen, a user controls operation of a software, such as a game, running on the electronic device.

There has been and remains a need for a customizable thumb grip cover that can securely affix to an analog controller stick and remain “centered” during use. These needs are met by the thumb grip cover of the present invention.

### SUMMARY OF THE INVENTION

One aspect of the present invention is directed to a thumb grip cover for an analog controller stick (“thumb grip cover”) comprised of
(a) a screw having
   (i) a head and
   (ii) a threaded shank, and
   (iii) a tip
(b) a hardened body comprised of
   (i) a top surface having a center hole
   (ii) a bottom surface with a cut-out, preferably a wedge-shaped, “C-shaped” or “U-shaped” channel, that ends at or close to the midpoint of the bottom surface
   (iii) sidewalls that connect the top surface and bottom surface and have an opening dimensioned to receive an uppermost portion of an analog controller stick, comprised of (xx) a hat (i.e., top) and (yy) a shaft
(c) optionally, but preferably at least one, more preferably at least two, deformable inserts, preferably made of foam, rubber or an elastomeric material, that engage(s) with one or both of the head and/or the shaft of the analog controller stick.
wherein the thumb grip cover is securely attached to the uppermost portion of the analog controller stick by twisting the screw downward through the center hole until the screw tip securely engages the hat of the analog controller stick, and further wherein the one or more deformable insert(s) prevent the hat and/or shaft of the analog controller stick from moving and/or vibrating.

A second aspect of the present invention is directed to a thumb grip cover comprised of
(a) a body having (i) a top surface, (ii) a bottom surface with a cut-out, preferably a wedge-shaped, “C-shaped” or “U-shaped” channel and (iii) sidewalls that connect the top surface and bottom surface and have an opening dimensioned to receive an uppermost portion of an analog controller stick, comprised of (xx) a hat (i.e., top) and (yy) a shaft,
(b) a first deformable insert, preferably made of foam, rubber or an elastomeric material, having a slit from an outer-edge of the first deformable insert to a midpoint thereof, that engages the shaft of the analog controller stick, and
(c) optionally, but preferably, a second deformable insert, preferably made of foam, rubber or an elastomeric material, that engages with the hat of the analog controller stick.

### BRIEF DESCRIPTION OF THE DRAWINGS

FIG. 1 is a cross-section of one embodiment of the thumb grip of the invention.

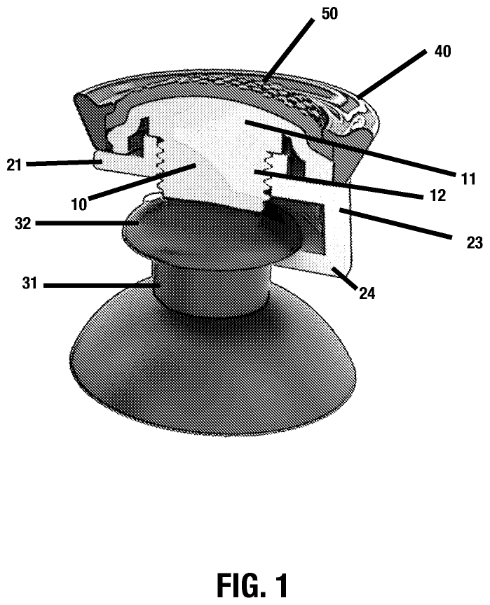

FIG. 2 is an exploded view of the thumb grip cover of the invention.

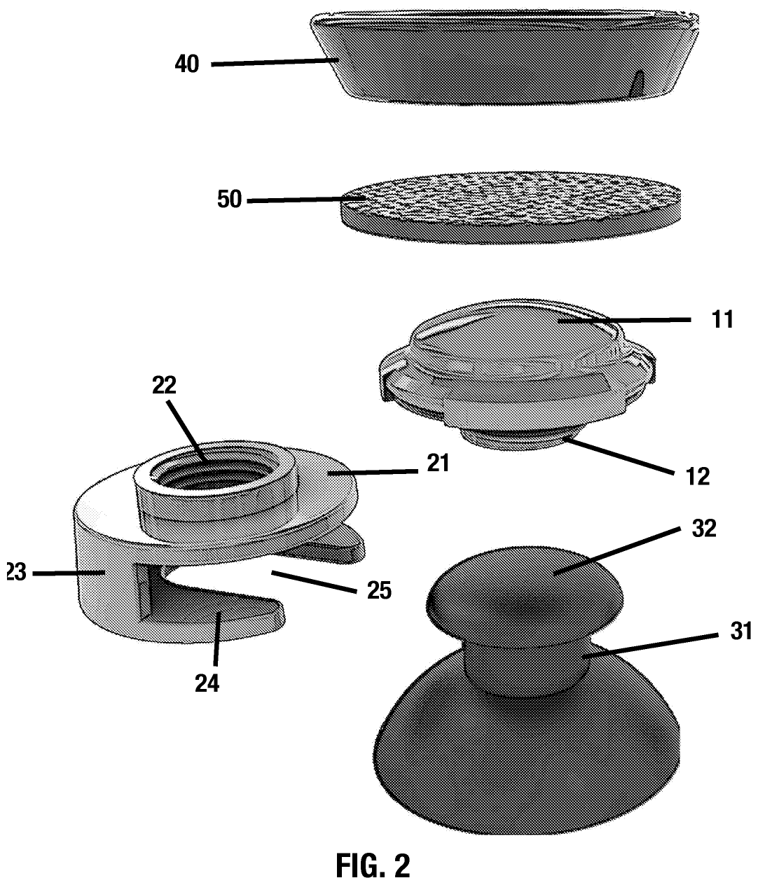

FIG. 3 is an exploded view of one embodiment of the invention showing two deformable inserts that engage with the analog controller stick.

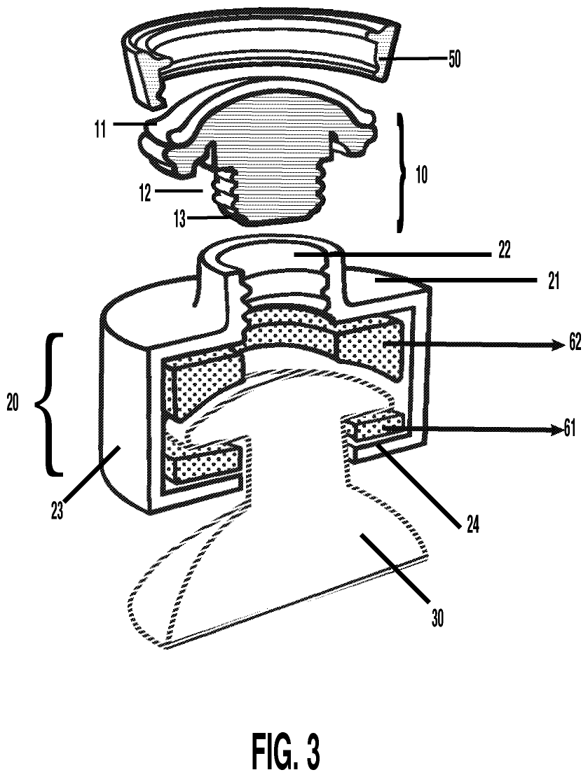

FIG. 4a is an exploded view of the two deformable inserts. FIG. 4b shows top views of the two deformable inserts.

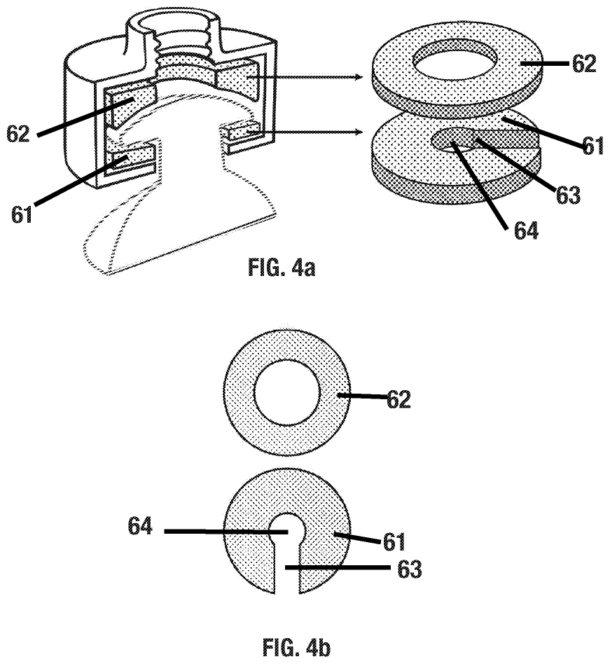

The analog controller stick is shown in dotted lines; the stick is not part of the claimed invention, but is considered necessary to show the environment in which the invention applied/used.

### DETAILED DESCRIPTION OF THE INVENTION

An “analog controller stick”—also referred to in the art of video gaming as a control stick, joystick, or thumbstick—is a lever that protrudes from a video game controller and provides input based on the position of the lever in relation to a default “center” position. The analog controller stick thus enables a user (sometimes referred to in the art as a “gamer”) to control (i.e., move, select, or manipulate) virtual objects on a video screen or other display device (e.g., virtual reality headset).

The uppermost portion of an analog controller stick is comprised of a hat (i.e., top) [32] and a shaft [31].

“Plastic” means a polymer that can be molded into shape while soft, and then set into a rigid or slightly elastic form. Non-limiting examples of plastics include acrylonitrile butadiene styrene polyethylene, and nylon.

The body of the thumb grip cover may be, and in preferred embodiments is, cylindrical in shape.

The screw [10] may be, and in preferred embodiments is, circular and is comprised of a head [11], a threaded shank [12], and a tip [13].

In these preferred embodiments, the circular screw head has one of the following convex head shapes: (i) pan, (ii) dome (also described as button), (iii) round, (iv) trussed (also described as mushroom), or (v) oval.

In other embodiments, the screw head is circular and concave.

In still other embodiments, the screw head is circular and flat.

In some embodiments, the screw of the thumb grip cover may be configured in the shape of a triangle, a square, an oval, a rectangle, a diamond, a trapezoid, or other polygons (e.g., a pentagon, a hexagon, or octagon).

In other embodiments, the body of the thumb grip cover may be configured in the shape of a triangle, a square, an oval, a rectangle, a diamond, a trapezoid, or other polygons (e.g., a pentagon, a hexagon, or octagon).

In some embodiments, the screw head may be configured in the same or different shape as the body. For example, a square body (i.e., cube) may have a circular screw head, or a triangular screw head, or a hexagonal screw head.

The screw head may be, and preferably is, decorated with a pattern.

The pattern may be created by applying or affixing to, or covering, the screw head with one or more decorative materials including, but not limited to, paint, varnish, lacquer, ink, enamel, coating, powder, glaze, glitter, as well as flexible fabric (woven or non-woven, natural or synthetic), rubber or rubber-like, plastic, vinyl, and/or sponge or sponge-like material.

Non-limiting examples of flexible fabric include leather and synthetic leather, where synthetic leather includes a plastic coating (usually a polyurethane) on a fibrous base layer (typically a polyester) covered with a plastic.

The pattern may also be created by one or more surface treatments, including etching, engraving, embossing or debossing, dimpling, polishing, and/or burnishing.

In certain preferred embodiments, the screw head is covered with a fabric.

In these preferred embodiments, the fabric covering is natural leather or synthetic leather, or a synthetic rubber, or tape.

In certain especially preferred embodiments, the fabric covering is the outermost (surface) material from which a ball used in an amateur or professional sport is constructed. The fabric covering of an amateur or professional sport ball is preferably selected from the group of baseball, football, soccer, basketball, golf or tennis.

The fabric covering used to make a football is pebble-grained, leather or synthetic leather, preferably tan or brown in color. The pebble grained leather or synthetic leather may have laces and/or stripes, preferably in white.

The fabric covering used to make a baseball is preferably a white (or off-white) cowhide or horsehide; optionally, but preferably, with waxed red threads sewn onto the surface of the baseball covering.

The fabric covering used to make a basketball is a rubber (synthetic or natural) or a leather (synthetic or natural); preferably in orange, red-orange or brown; and even more preferably Pantone Matching System (PMS) Orange 151, PMS Red-Orange 173 or PMS Brown 1535.

The fabric covering used to make a soccer ball is a synthetic leather comprised of polyurethane or polyvinyl chloride. Preferably, the soccer ball covering is at least two, preferably at least three, hexagonal or pentagonal panels, or portions thereof. One or more of the hexagonal or pentagonal panels (or portions thereof) are preferably white; with the remaining panel(s) in a color other than white, preferably black.

The fabric covering used to make a tennis ball is a fibrous felt, where the fibers may be one or both of wool and nylon. Preferably the tennis ball fabric covering is yellow in color, even more preferably fluorescent yellow (also known as “optic yellow”).

While the fabric covering [50] (preferably used to make a sport ball) may be adhered directly to the screw head, in certain preferred embodiments, the fabric covering is clamped to the screw head with a collar [40] that snuggly fits around the perimeter of the screw head, and preferably locks onto or under the screw head perimeter.

In especially preferred embodiments, in which the screw head is circular, the collar is a ring constructed of plastic that fits snugly around the circumference of the screw.

The collar, which may be the same or a different shape than the screw, may be the same or a different color/pattern than the body. The collar may have one or more surface treatment(s) as described above with reference to the screw. The top surface of the body of the thumb grip cover [21] has a threaded hole [22] that engages with the threaded shank of the screw head [12].

The bottom surface of the body of the thumb grip cover has a cut-out [25] that is dimensioned to receive the shaft of an analog controller stick.

Preferably, the top surface and the bottom surface of the thumb grip cover have the same dimensions in the x-y plane.

The cut-out in the bottom surface of the thumb grip may, in certain embodiments, be “wedge-shaped”.

In other embodiments, the cut-out may be in the form of a “C”, a “U”, or a crescent.

In embodiments in which the cut-out in the bottom surface is wedge-shaped, the central angle of the wedge-shaped section is preferably greater than about 30 degrees, more preferably greater than about 45 degrees, still more preferably greater than about 60 degrees, even more preferably greater than about 90 degrees.

The hat of the analog controller stick is often wider than the shaft. Accordingly, the sidewalls [23] that connect the top surface of the body to the bottom surface of the body have an opening dimensioned to receive both the hat and the shaft of the analog controller stick.

In cylindrical embodiments, the sidewall spans from at least about 1 radian to about n radians, preferably, the sidewall connects to about ½ of the circumference of both the top surface and the bottom surface.

Often the hat of the analog controller stick has rounded edges and has a shape that is pan, dome, round, truss, or oval. In order to create contact with a larger surface area of the hat, and thereby the secure analog controller stick within the body of the thumb grip cover, at least one annular, deformable washer insert [62] may be, and preferably is inserted below the top surface of the body and above the hat.

Annular deformable washer inserts with different sized internal circumferences may be, and preferably are, provided with thumb grip covers of the present invention.

In certain embodiments, two (or more) annular inserts with different sized internal circumferences may be stacked on top of each other and inserted below the top surface of the body and above the hat.

In other embodiments, a deformable insert [61] with a channel/slit [63] cut from the outermost edge to about a midpoint in the insert [64] is inserted above the bottom surface of the body. The channel and midpoint are sufficiently narrow to engage with the shaft, and thereby prevent side-to-side movement.

The deformable insert [61] that engages the shaft [31] of the analog controller stick at the midpoint [64] is preferably rotated so that the channel/slit [63] is facing inward towards the sidewall [23]. In this manner, the deformable insert [61] functions as a locking mechanism.

In certain embodiments, two (or more) deformable inserts, each from the outermost edge to about the midpoint, may be stacked on top of each other and inserted above the bottom surface of the body and below the hat.

A variety of materials known to the skilled artisan may be used to fabricate the thumb grip covers of the present invention.

Preferably, the screw, body, and collar are constructed each from a plastic. In certain embodiments, the screw, body and/or collar may be constructed from metal or rubber.

In preferred embodiments, the materials used to fabricate the screw, screw covering, and body are biodegradable.

As illustrated in the Figures, one embodiment of the thumb grip cover of the present invention as fully assembled is comprised of a collar [40] clamping a flexible fabric covering [50] on to a screw [10] having a head [11], threaded shank [12] and a tip [13], and a hardened body having a top surface [21], a center hole [22], a bottom surface [24] with a cut-out [25] and sidewalls [23] attached to an analog controller stick [30] having a hat [32] and a shaft [31]. A bottom deformable insert [61] engages with the shaft of the analog controller stick. A top deformable insert [62] engages with the hat of the analog controller stick.

1-11. (canceled)

12. A thumb grip cover comprised of
(a) a body having
(i) a top surface
(ii) a bottom surface with a cut-out
(iii) sidewalls that connect the top surface and bottom surface
(b) a first deformable insert, preferably made of foam, rubber or an elastomeric material, having a slit from an outer edge of the first deformable insert to a midpoint thereof, that engages the shaft of the analog controller stick, and
(c) optionally, but preferably, a second deformable insert, preferably made of foam, rubber or an elastomeric material, that engages with the hat of the analog controller stick
wherein the top surface, the bottom surface, and the sidewalls form an opening dimensioned to receive an uppermost portion of an analog controller stick, comprised of (xx) a hat (i.e., top) and (yy) a shaft.
